(19) United States
(12) Patent Application Publication
(10) Pub. No.: US 2022/0153100 A1
(43) Pub. Date: May 19, 2022

(54) DOOR MODULE OF A VEHICLE DOOR AND VEHICLE DOOR HAVING THE DOOR MODULE

(71) Applicant: Brose Fahzeugteile SE & Co. Kommanditgesellschaft, Bamberg, Bamberg (DE)

(72) Inventors: Dominik Dobias, Myjava (SK); Christian Dallos, Poruba (SK); Matthias Ittermann, Untersiemau (DE); Hans Herzog, Strullendorf (DE); Michael Jahn, Bad Staffelstein (DE)

(21) Appl. No.: 17/665,733

(22) Filed: Feb. 7, 2022

Related U.S. Application Data
(63) Continuation of application No. PCT/EP2020/071772, filed on Aug. 3, 2020.

(30) Foreign Application Priority Data
Aug. 6, 2019 (DE) 10 2019 211 789.9
Nov. 29, 2019 (DE) 10 2019 218 580.0

(51) Int. Cl. B60J 5/04

(52) U.S. Cl. CPC B60J 5/0468; E05F 15/689; B60J 5/0415; B60J 5/0413

(57) ABSTRACT

A door module of a vehicle door includes a carrier plate having a cable window regulator with at least one guide rail, and a door structure which is or can be joined to the carrier plate. A cable deflection region of the guide rail extends beyond an outer edge of the carrier plate. The cable deflection region is provided with a joining contour which, when joined, is form-lockingly inserted in a receiving contour of the door structure. The joining contour engages behind the receiving contour in such a way that the cable deflection region is stabilizingly held in a direction perpendicular to the cable deflection region. A vehicle door having the door module is also provided.

### CROSS-REFERENCE TO RELATED APPLICATION

This application is a continuation, under 35 U.S.C. § 120, of copending International Patent Application PCT/EP2020/071772, filed Aug. 3, 2020, which designated the United States; this application also claims the priority, under 35 U.S.C. § 119, of German Patent Applications DE 10 2019 211 789.9, filed Aug. 6, 2019, and DE 10 2019 218 580.0, filed Nov. 29, 2019; the prior applications are herewith incorporated by reference in their entirety.

### FIELD AND BACKGROUND OF THE INVENTION

The invention relates to a door module of a vehicle door, including a carrier plate having a cable window regulator with at least one guide rail, as well as a door structure which is or can be joined to the carrier plate. The invention further relates to a vehicle door having such a door module.

A door body of a vehicle door generally has a door outer panel forming the door outer skin of the vehicle door and a door inner panel on the vehicle inner side, the door inner panel being connected to the door outer panel and a hollow space being configured therebetween as a mounting space into which functional elements or functional components of the vehicle door, such as for example a window regulator, a door lock, an airbag or the like are disposed.

In order to mount the functional components, it is possible to premount the components on a carrier plate, also called a door module carrier or unit carrier. The equipped carrier plate is then able to be positioned onto a mounting opening of the vehicle door or of the door inner panel in order to cover the mounting opening, in particular in order to produce a wet space/dry space separation. During the installation of the carrier plate in the vehicle door it may additionally be necessary to mount certain functional components, such as for example guide rails of a window regulator, on a door structure or a body of the vehicle door.

Window regulators for vehicle doors are constructed, for example, with a cable pull mechanism for lifting and for lowering a (window) pane. In such a window regulator, the pane is guided along at least one guide rail by using a driver element or rail sliding element. The cable pull mechanism typically has a cable pull which is guided, on one hand, in a cable drum which winds and unwinds the cable pull and, on the other hand, by a single or repeated deflection on the driver element or rail sliding element and is fixed there.

The deflection of the cable pull generally takes place by using cable deflection pulleys which are disposed in the front-side end regions of the guide rail, which are also denoted hereinafter as cable deflection regions. In that case, the cable deflection pulleys are positioned on bearing points and mounted thereon so as to be able to turn or rotate.

In order to mount the carrier plate on the door structure, one of the cable deflection regions of a guide rail may protrude beyond the outer edge of the carrier plate and may be inserted into a receiver of the door structure. Due to the substantially exposed cable deflection region, however, on one hand the mechanical strength and stability of the window regulator or the guide rail in that region is disadvantageously reduced and, on the other hand, the mechanical stress is disadvantageously increased due to the leverage.

In order to stabilize the cable deflection region, it is generally mechanically coupled to the door structure. To that end, for example, bearing points penetrated by bolts or screws are conceivable, in which a fastening screw or a fastening bolt at least partially penetrates the bearing point along the axis of rotation of the cable deflection pulley and is held on the top side on the receiver or the door structure. The bearing point in that case has, for example, an internal thread. The cable deflection region is force-lockingly joined or fastened by using screws to the door structure. However, an additional mounting step is required during the mounting of the vehicle door due to the screw fastening.

In order to avoid that mounting step, for example, cable deflection regions having bearing points without bolts or screws are also possible, i.e. bearing points which in the mounted state are not penetrated by a fastening element, such as for example a fastening screw or a fastening bolt. In such embodiments, the cable deflection region is typically not connected directly to the door structure or joined thereto. In other words, there is generally no direct mechanical coupling between the cable deflection region and the door structure, whereby the mechanical stability of the cable deflection region is disadvantageously reduced. As a result, due to the forces acting on the cable deflection pulley through the guided cable pull, movements and (deflection), bending or deformation of the cable deflection region may occur, for example ranging between 5-6 mm (millimeters) during the operation of the window regulator. In particular, it may arise that the cable deflection region comes into contact with the guided windowpane or a driver element or rail sliding element, whereby undesired noise development is generated. Thus, such cable deflection regions which do not have screws or bolts are frequently provided with an additional damping element.

### SUMMARY OF THE INVENTION

It is accordingly an object of the invention to provide a particularly suitable door module of a vehicle door and a vehicle door having the door module, which overcome the hereinafore-mentioned disadvantages of the heretofore-known door modules and vehicle doors of this general type and in which, in particular, a connection between a carrier plate and a door structure which may be produced in a manner which is as stable and simple as possible is intended to be permitted.

With the foregoing and other objects in view there is provided, in accordance with the invention, a door module of a vehicle door, comprising a carrier plate having a cable window regulator having at least one guide rail, and a door structure which is or can be joined to the carrier plate, wherein the guide rail extends with a cable deflection region beyond an outer edge of the carrier plate, the cable deflection region is provided with a joining contour which, in the joined state, is form-lockingly inserted in a receiving contour of the door structure, and the joining contour engages behind the receiving contour in such a way that the cable deflection region is stabilizingly held in a direction perpendicular to the cable deflection region.

With the objects of the invention in view, there is also provided a door module of a vehicle door, comprising a carrier plate having a cable window regulator having at least one guide rail, and a door structure which is or can be joined to the carrier plate, wherein the guide rail extends with a cable deflection region beyond an outer edge of the carrier plate, the cable deflection region is provided with a multipiece joining contour which, in the joined state, is form-lockingly inserted in a one-piece or multipiece receiving contour of the door structure, and the joining contour engages behind the receiving contour in such a way that the cable deflection region is stabilizingly held in a direction perpendicular to the cable deflection region.

With the objects of the invention in view, there is concomitantly provided a vehicle door having the door module.

Advantageous embodiments and developments form the subject matter of the respective subclaims. The advantages and embodiments set forth regarding the door module are also expediently able to be transferred to the vehicle door and vice versa.

The door module according to the invention is constructed, in particular, as a door subassembly of a vehicle door. The door module in this case has a carrier plate as a door module carrier or unit carrier, a premounted cable window regulator, for example, with at least one guide rail being disposed thereon. The door module also has a door structure, in particular in the form of a door inner panel or a window frame structure which is or can be joined to the carrier plate.

In this case, the guide rail extends with a cable deflection region beyond an outer edge of the carrier plate. In other words, the cable deflection region of the guide rail protrudes over the outer periphery of the carrier plate.

In this case, the cable deflection region is configured, in particular, as a (joining) interface of the carrier plate with the door structure. In this case, the cable deflection region is provided with a joining contour which, in the joined or mounted state, is form-lockingly inserted in a receiving contour of the door structure. The joining contour is formed, for example, in one piece, i.e. integrally or monolithically, on the cable deflection region, or is constructed in multiple pieces, i.e. as one or more separate components therefrom. The receiving contour is also configured, for example, in one piece or in multiple pieces relative to the door structure.

In this case, according to the invention the joining contour is constructed and embodied in such a way that when the joining contour is inserted in the receiving contour, the joining contour at least partially engages behind the receiving contour in such a way that the cable deflection region is stabilizingly held in a direction oriented perpendicular thereto. In other words, the joining contour form-lockingly engages behind the receiving contour in the perpendicular direction at least in some sections, whereby the cable deflection region is mechanically stabilized in this direction. This means that the joining contour of the cable deflection region is hooked behind the door structure in the region of the receiving contour. As a result, a particularly suitable door module is produced.

Due to the form-locking between the joining contour and the receiver a mechanical coupling is produced between the cable deflection region and the door structure which, in an operationally safe and reliable manner, mechanically stabilizes the cable deflection region regarding forces occurring during operation. In other words, loads, stresses and forces which occur and which act on the cable deflection region are at least partially transferred to the door structure. This means that according to the invention the (joining) interface between the carrier plate and the door structure improves the mechanical stiffness or strength of the cable window regulator or the guide rail.

In particular, therefore, undesired movements, mechanical (deflection), bending or deformation of the cable deflection region are avoided or at least reduced in an advantageous and structurally simple manner. As a result, it is possible to construct the cable deflection region without an additional damping element since the risk of undesired noise development is avoided in an advantageous and simple manner by the mechanical stabilizing.

A “form-locking” or a “form-locking connection” between at least two parts connected together is understood to mean in this case and hereinafter, in particular, that the parts which are connected together are held together in at least one direction by a direct interlocking of the contours of the parts themselves or by an indirect interlocking through an additional connecting part. A mutual movement is “blocked” in this direction, therefore, as a result of the shape.

Information regarding the spatial directions is also specified hereinafter, in particular, in a coordinate system of the motor vehicle (vehicle coordinate system) relative to an exemplary installed situation of the door module in a side door of the motor vehicle. The abscissa (X-axis, X-direction) is in this case oriented in the vehicle longitudinal direction (driving direction) and the ordinate axis (Y-axis, Y-direction) is oriented in the vehicle transverse direction and the applicate axis (Z-axis, Z-direction) is oriented in the vehicle vertical direction.

The cable deflection region protrudes over the carrier plate, in particular in the Z-direction. The joining contour engages behind the receiving contour, in this case preferably in the Y-direction. In other words, the carrier plate and the door structure are form-lockingly joined together in the Y-direction.

In a preferred embodiment, the cable deflection region is constructed with a bearing point without screws or bolts, a cable deflection pulley being mounted thereon so as to be able to turn or rotate. In other words, an additional separate fastening element is not provided between the cable deflection region and the door structure.

As a result, a suitable cable deflection region which permits a mounting of the door module in a manner which is particularly simple and with reduced effort is produced. In particular, therefore, an additional mounting step, in which for example a fastening screw is screwed into an internal thread of the bearing point in order to couple the cable deflection region to the door structure in a stabilizing manner, is eliminated.

In an advantageous embodiment, the joining contour is disposed on a side of the cable deflection region opposing the bearing point. In other words, the bearing point is disposed, for example, on a front face of the cable deflection region which is disposed on a planar side of the carrier plate bearing the cable window regulator. The joining contour is correspondingly disposed on an opposing rear face of the cable deflection region. As a result, a coupling which is simple and compact in terms of installation space is possible between the cable deflection region and the door structure and which has substantially no structural effects on the bearing point or the cable deflection pulley.

In an expedient embodiment, the joining contour is inserted or insertable into the receiving contour in a rail longitudinal direction (mounting direction). The rail longitudinal direction in this case is oriented substantially in the Z-direction. The receiving contour is constructed, for example, as a lead-through opening of the door structure, the joining contour being at least partially guided therethrough. The joining contour and the receiving contour in this case engage in one another in the rail longitudinal direction or mounting direction in the manner of a key-lock principle, wherein the receiving contour is configured substantially as the keyhole and the joining contour is configured as the key. As a result, a mounting of the door module is ensured in a manner which is particularly simple and with reduced effort.

For example, it is conceivable that the window regulator or guide rail -and thus the cable deflection region—are produced from a metal. In a preferred and structurally particularly simple and component-reducing embodiment, at least the cable deflection region is constructed as an injection-molded part, the joining contour being integrally formed, i.e. in one piece or monolithically, thereon. As a result, a production of the door module is implemented in a manner which is simple and with reduced effort and costs.

In a conceivable development, in this case the joining contour is produced without a slide during the injection-molding process. In other words, an additional movable slide is not required for demolding the joining contour from an injection-molding tool. Thus, in order to provide partial injection-molded regions of the joining contour no auxiliary parting planes are generated during the injection-molding process. The injection-molded part, i.e. the cable deflection region, and the joining contour may thus be substantially demolded with a simple functioning open-shut injection-molding tool in a main demolding direction. As a result, a particularly simple and cost-effective production of the door module is ensured.

In a suitable embodiment, the joining contour has a substantially T-shaped cross-sectional shape. The joining contour has the T-shaped geometry, in this case in particular in an XY-plane, wherein the joining contour in particular extends in the Z-direction. As a result, a particularly simple and expedient embodiment of the joining contour is produced.

In a conceivable development, the vertical T-shaped limb of the joining contour engages form-lockingly in a guide slot of the receiving contour. The vertical T-shaped limb in the mounted state is oriented, in particular, in the Y-direction. The guide slot in this case is preferably oriented in the rail longitudinal direction, i.e. the mounting direction or substantially in the Z-direction. The guide slot thus acts, in particular, as a positioning or mounting aid when joining the door structure and the carrier plate. Moreover, a form-locking of the vertical T-shaped limb and thus of the cable deflection region is produced in the X-direction by the guide slot.

The horizontal T-shaped limb, which in the mounted state is oriented, in particular, in the X-direction, engages behind the receiving contour at least in some sections so that the form-locking between the cable deflection region and the door structure is produced in the Y-direction. This means that the horizontal T-shaped limb is substantially disposed on a surface of the door structure or the receiving contour remote from the cable deflection region.

In an alternative, equally preferred embodiment, the joining contour has two bearing surfaces which face one another for the door structure. The bearing surfaces in this case are expediently constructed to be in parallel and spaced apart from one another in the Y-direction. A clear width or spacing is thus configured as a receiver between the bearing surfaces. The receiving contour in this case has a mating surface which is form-lockingly gripped, in particular form and force-lockingly, between the bearing surfaces. Thus a mounting which is particularly simple and with reduced effort is permitted by the joining contour. In the mounted state, the cable deflection region is thus fixed in a manner which is particularly reliable and stable in the Y-direction. As a result, noise developments due to relative movements between the components are advantageously and effectively avoided or at least reduced.

A “force-locking” or a “ force-locking connection” between at least two parts which are connected together is understood to mean in this case and hereinafter, in particular, that the parts which are connected together are prevented from sliding off one another due to a frictional force acting therebetween. If a “connecting force” producing this frictional force is absent (this means the force which pushes the parts together, for example a screwing force or the weight force itself) the force-locking connection may not be maintained and thus may be released.

This embodiment of the joining contour and receiving contour permits a particularly simple adjustment of a tool for joining or mounting the door structure to the cable deflection region of the carrier plate. As a result, the mounting is simplified and the mounting or production costs advantageously reduced.

The bearing surfaces are disposed, for example, asymmetrically, i.e. for example offset relative to one another in the X- and/or Z-direction.

It is also conceivable, for example, that the joining contour or the bearing surfaces are formed by using different components. In other words, for example, it is possible that a (first) bearing surface of the joining contour is integrally formed on the cable deflection region, and that the second bearing surface is constructed as a separate component which is mounted or joined onto the cable deflection region for forming the joining contour. For example, it is possible in this case for the joining contour or the bearing surfaces of the door structure itself to be formed by, for example, two different components, for example by using a frame part and a crash tube.

In a suitable development, the mating surface has a stepped contour, i.e. a surface offset, in particular in the Y-direction, which is encompassed by the bearing surfaces. Thus, during the mounting procedure the stepped contour acts as a tolerance compensation in the Y-direction. As a result, a particularly stable hold of the cable deflection region is produced on the receiving contour.

In an expedient embodiment, at least one of the bearing surfaces is provided at the free end side with a lead-in portion, i.e. with a bevel-like guide contour. As a result, a particularly simple insertion of the mating surface between the bearing surfaces is possible, whereby the mounting is simplified.

In an advantageous embodiment, the joining contour is constructed to be at least partially resilient or flexible. This means that, for example, at least one of the bearing surfaces is configured to be resilient. Preferably, therefore, the bearing surfaces of the joining contour are hooked behind with a certain amount of mechanical pretensioning, so that in the mounted or joined state the mating surface is held force-lockingly in a clamped manner between the bearing surfaces. As a result, a particularly stable fastening is produced.

In an embodiment which is particularly low in noise and without rattling, the joining contour is provided with a damping element. The damping element is disposed in this case between at least one bearing surface and the mating surface. The damping element is constructed, for example, as a damper which is positioned or plugged onto the joining contour or bearing surfaces, in particular a damper made of an ethylene-propylene-diene-rubber (for short EPDM, ethylene-propylene-diene; M-group) or as an injection-molded flexible component, for example a two-component sealing foam (2K sealing foam).

In a particularly stable embodiment, the joining contour is provided with a reinforcing rib. This means that the joining contour is mechanically reinforced or stabilized thereby. This produces a particularly stable joining contour which as a result is transferred into a particularly stable and operationally reliable form-locking between the cable deflection region and the door structure.

In a preferred application, the door module is a part of a vehicle door, in particular a side door of a motor vehicle. As a result, a particularly suitable and cost-effective vehicle door is produced.

Other features which are considered as characteristic for the invention are set forth in the appended claims.

Although the invention is illustrated and described herein as embodied in a door module of a vehicle door and a vehicle door having the door module, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, elevational view of a cable window regulator of a vehicle door;

FIG. 2 is a fragmentary, perspective view of a cable deflection region of the cable window regulator;

FIG. 3 is a front-elevational view a door module of a vehicle door with a carrier plate and with a door structure;

FIG. 4 is a plan view of a receiving contour of the door structure in a first embodiment;

FIG. 5 is a perspective of a joining contour of the cable deflection region in a first embodiment;

FIG. 6 is a plan view of the joining contour in the first embodiment;

FIG. 7 is a perspective view of the joining contour and the receiving contour in a joining process;

FIG. 8 is a perspective view of an outer face of the joint connection between the joining contour and the receiving contour;

FIG. 9 is a perspective view of an inner face of the joint connection between the joining contour and the receiving contour;

FIG. 10 is a perspective view of a joining contour of the cable deflection region in a second embodiment;

FIG. 11 is a perspective view of a receiving contour of the door structure in a second embodiment;

FIG. 12 is a perspective view of the joint connection between the joining contour and the receiving contour according to the second embodiment;

FIG. 13 is a perspective view of the joining contour in a third embodiment;

FIG. 14 is a perspective view of the joining contour in the third embodiment;

FIG. 15 is a perspective view of the receiving contour in a third embodiment; and

FIG. 16 is a perspective view of the receiving contour in the third embodiment.

### DETAILED DESCRIPTION OF THE INVENTION

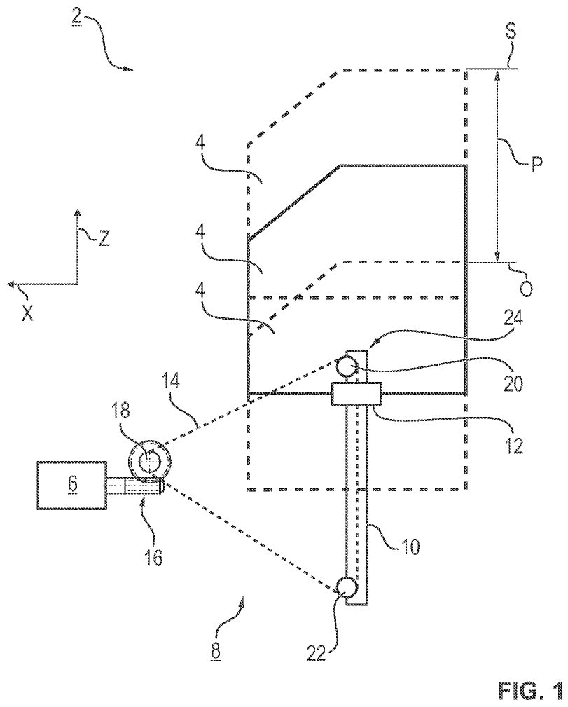

Referring now in detail to the figures of the drawings, in which parts and sizes which correspond to one another are always provided with the same reference numerals, and first, particularly, to FIG. 1 thereof, there is seen a simplified and diagrammatic view of an electrical window regulator 2 as an actuating device for a (vehicle) windowpane 4 of a motor vehicle.

The window regulator 2 has an actuating motor 6 which acts by using an actuating mechanism 8 on the windowpane 4. The actuating mechanism 8 has a guide rail 10 and a driver element or rail sliding element 12 coupled to the windowpane 4.

In the exemplary embodiment shown, the window regulator 2 is constructed as a simply guided cable window regulator. The actuating mechanism 8 in this case has a cable pull 14 in addition to the guide rail 10.

The actuating motor 6 of the window regulator 2 drives a cable drum 18 of the actuating mechanism 8 through a worm gear or spur gear 16. A pull cable of the cable pull 14 is disposed on the cable drum 18, in such a way that when the cable drum 18 is rotated, brought about by the gear mechanism 16, the pull cable is wound up and unwound.

An upper cable deflection pulley 20 and a lower cable deflection pulley 22 which are disposed on opposing (rail) front faces are fastened to the guide rail 10. The pull cable of the cable pull 14 is guided around the cable deflection pulleys 20, 22.

When the actuating motor 6 is actuated, the windowpane 4 is moved into the (pane) position P thereof. The windowpane 4 in this case is reversibly movable between a closed position S, which represents the highest possible position P, and an open position O which represents the lowest possible position P. In these positions S and O the windowpane 4 is indicated in each case in dashed lines in FIG. 1. However, in a half-open intermediate position the windowpane 4 is represented by solid lines.

Hereinafter, information regarding the spatial directions is also specified in a coordinate system of the motor vehicle (vehicle coordinate system) relative to the exemplary installed situation in a side door of the motor vehicle. The abscissa axis (X-axis) in this case is oriented in the vehicle longitudinal direction, the ordinate axis (Y-axis) is oriented in the vehicle transverse direction and the applicate axis (Z-axis) is oriented in the vehicle vertical direction.

The longitudinal direction of the guide rail 10 (rail longitudinal direction) in this case is oriented approximately parallel to the applicate axis (Z), wherein the transverse direction of the guide rail 10 (rail transverse direction) is oriented substantially parallel to the abscissa axis (X). The vertical direction of the guide rail 10 (rail vertical direction) is oriented perpendicular to the rail transverse direction and the rail longitudinal direction and thus runs approximately parallel to the ordinate axis (Y).

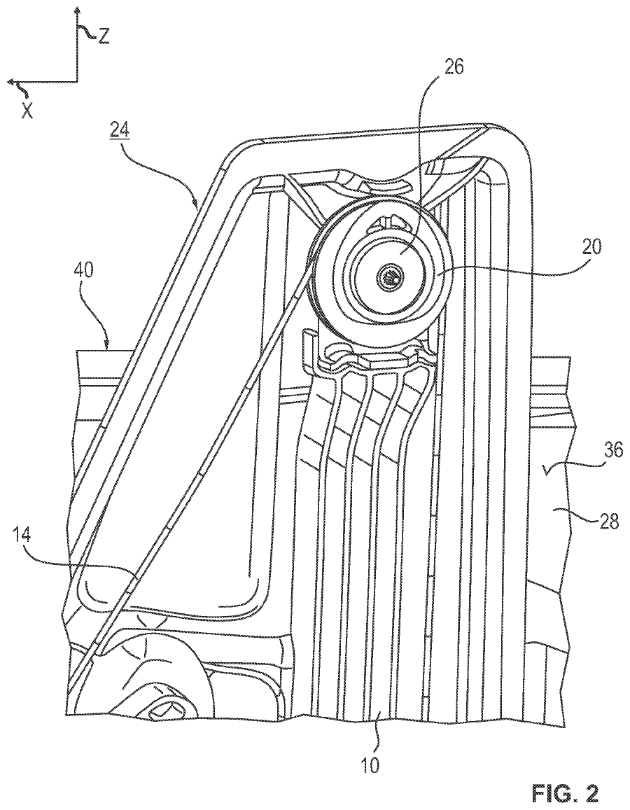

In FIG. 2 a section of a cable deflection region 24 of the window regulator 2 or the guide rail 10, i.e. the front-side rail end region on which the cable deflection pulley 20 is disposed, is shown in more detail.

The cable deflection region 24 shown in FIG. 2 has an approximately cylindrical bearing point 26 which is integrally formed, i.e. in one piece or monolithically, the cable deflection pulley 20 being positioned thereon so as to be able to rotate or turn. The bearing point 26 or the cable deflection region 24 in this case are constructed without screws or bolts, and this means that no additional fastening elements are disposed in the bearing point 26.

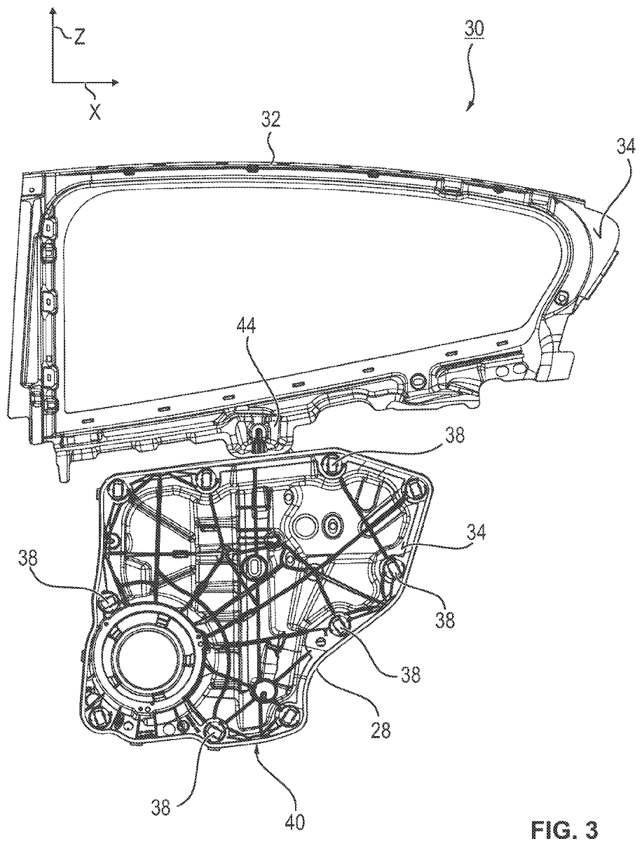

In the mounted state, the window regulator 2 is premounted on a carrier plate 28 of a door module 30 shown in FIG. 3. The carrier plate 28 is configured and provided to be fixed to a door structure 32. In this case, the carrier plate 28 is configured as a (door) module carrier or unit carrier on which further functional components of a vehicle door, not shown in more detail, may be mounted in addition to the window regulator 2. In the exemplary embodiment shown in the figures, the door structure 32 is configured as a window frame structure and in this case may also be constructed as part of a door inner panel.

When the door module 30 is installed as intended in a side door of a motor vehicle, this door module—and also the carrier plate 28 and the door structure 32—has an inner face 34 and an outer face 36. In this case in the installed or mounted state, the inner face 34 faces an interior (passenger compartment) of the motor vehicle and the outer face 36 faces a region outside the motor vehicle. FIG. 3 shows a view of the inner face 34 of the door module 30.

A plurality of interfaces may be seen on the inner face 34 of the door module 30 or the carrier plate 28 for connecting to a door frame, not shown in more detail, of the door structure 32 or of the door inner panel, in the form of fastening openings 38. In this case the fastening openings 38 are disposed on an edge 40 of the carrier plate 28. The fastening openings 38 are provided in the figures with reference numerals merely by way of example.

As is visible for example in FIG. 2, the guide rail 10 extends with the cable deflection region 24 beyond the outer edge 40 of the carrier plate 28. In particular, the cable deflection region 24 in this case protrudes approximately perpendicularly above the upper edge of the carrier plate 28.

In this case the cable deflection region 24 is configured as a (joining) interface of the carrier plate 28 with the door structure or the window frame structure 32 of the door inner panel.

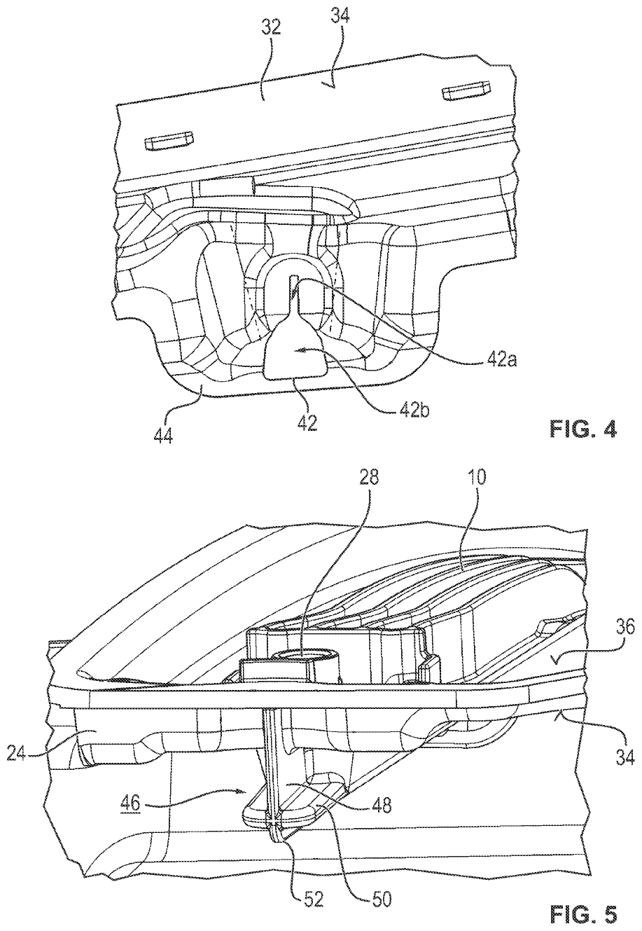

As is shown for example in FIG. 4, the door structure 32 has a receiving contour 42 in the form of a lead-through opening penetrating the door structure 32. The receiving contour 42 is incorporated in an operating region 44 of the door structure 32, the operating region being integrally formed on a lower edge of the door structure 32 facing the carrier plate 28. The receiving contour 42 in this case has a relatively narrow slot region or guide slot 42a and a relatively wide insertion region 42b leading therein.

FIG. 5 shows the cable deflection region 24 in a perspective plan view. As is relatively clearly visible in FIG. 5, the cable deflection region 24 is provided with a protruding joining contour 46 which is form-lockingly inserted in the receiving contour 42 of the door structure 32 in the joined or mounted state shown in FIG. 3.

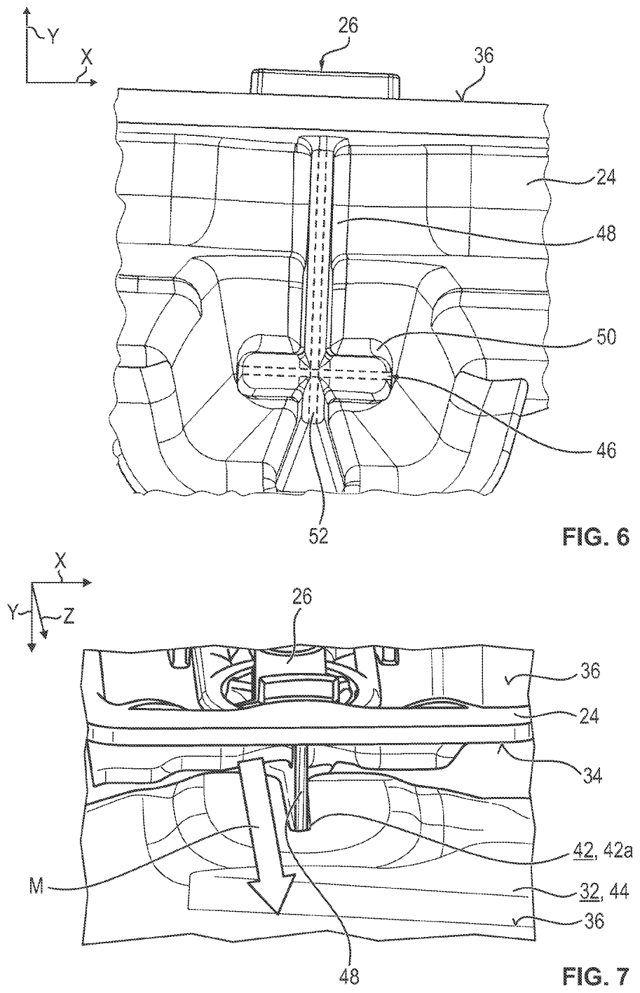

The joining contour 46 and the function thereof is described in more detail hereinafter with reference to FIGS. 6 to 9.

The guide rail 10 or at least the cable deflection region 24 is produced as an injection-molded part in which the joining contour 46 is integrally formed, i.e. in one piece or monolithically. The joining contour 46 in this case is disposed on a side of the cable deflection region 24 opposing the bearing point 26. In the exemplary embodiment shown, the joining contour 46 is disposed on the inner face 34 of the cable deflection region 24.

As is visible in particular in FIG. 6, the joining contour 46 in this case has in the XY-plane a substantially T-shaped cross-sectional shape with a vertical T-shaped limb 48 oriented approximately along the Y-axis, and with a horizontal T-shaped limb 50 oriented approximately in the X-direction. The T-shape is shown in dashed lines in FIG. 6. A reinforcing rib 52 is integrally formed on the T-shaped limb 50 as an extension of the T-shaped limb 48. The joining contour 46 and the reinforcing rib 52 extend in this case along the Z-axis.

Due to the T-shaped geometry, the joining contour 46 may be produced without a slide during the injection-molding process of the cable deflection region 24.

The joining contour 46 is constructed and embodied in such a way that when the joining contour is inserted in the receiving contour 42, the joining contour 46 at least partially form-lockingly engages behind the receiving contour 42 in such a way that the cable deflection region 24 is stabilizingly held along the Y-axis. This means that loads, stresses and forces which occur between the cable deflection region 24 and the door structure 32 by using the joint connection, and which act on the cable deflection region 24 or the bearing point 26, are at least partially transferred to the door structure 32.

As is shown in FIG. 7, the joining contour 46 is inserted into the receiving contour 42 in a mounting direction M which is oriented substantially in the rail longitudinal direction or Z-direction. In this case, the joining contour 46 is guided in the insertion region 42b and the guide slot 42a.

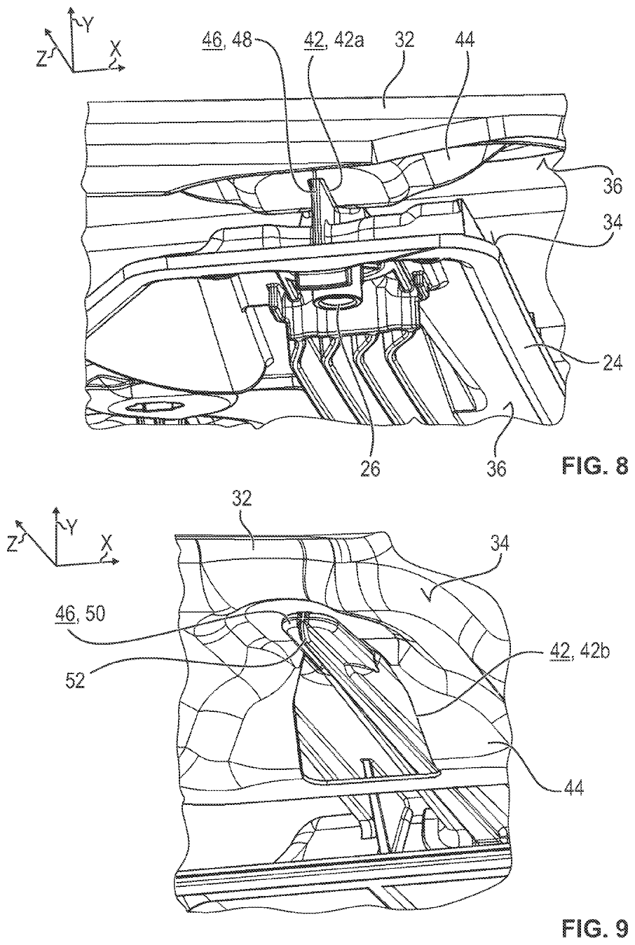

As is relatively clearly visible in FIGS. 8 and 9, the vertical T-shaped limb 48 of the joining contour 46 in the inserted state or joined state (mounted state) engages form-lockingly in the guide slot 42a of the receiving contour 42. The guide slot 42a is oriented at least partially along the Z-axis. The guide slot 42a thus acts, in particular, as a positioning or mounting aid or insertion aid when joining the door structure 32 and the carrier plate 28. Moreover, a form-locking of the vertical T-shaped limb 48 and thus of the cable deflection region 24 is produced by the guide slot 42a along the X-axis.

As is relatively clearly visible in FIGS. 8 and 9, the T-shaped limb 48 of the joining contour 46 is disposed substantially between the inner face 34 of the cable deflection region 24 and the outer face 36 of the operating region 44. The T-shaped limb 50 is disposed on the inner face 34 of the operating region 44 or of the door structure 32, so that the horizontal T-shaped limb 50 engages at least in some sections behind the guide slot 42a of the receiving contour 42. As a result, a more reliable and operationally safe form-locking is produced between the cable deflection region 24 and the door structure 32 along the Y-axis.

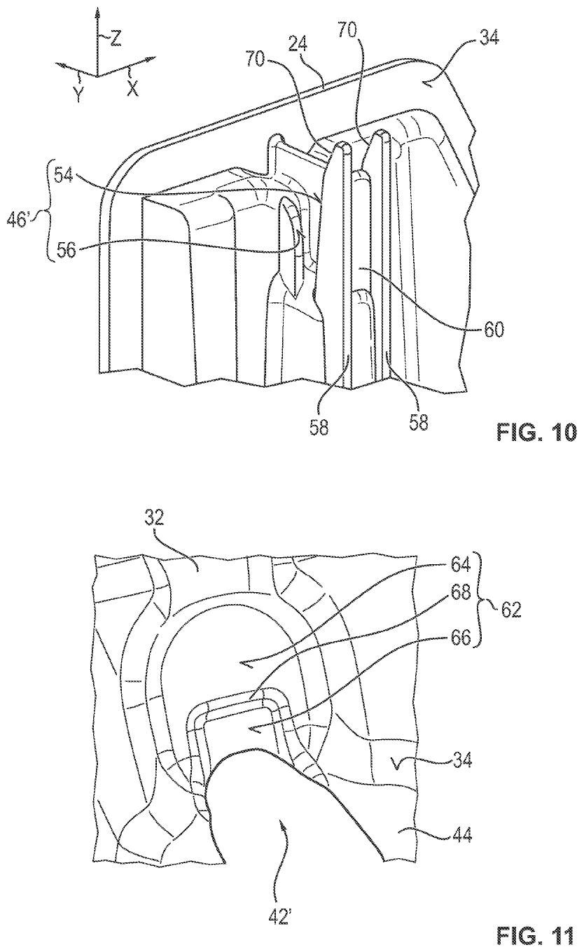

A second exemplary embodiment of the receiving contour 42′ and the joining contour 46′ is described in more detail hereinafter with reference to FIGS. 10 to 12.

The joining contour 46′ shown in FIG. 10 has in this embodiment two bearing surfaces 54 and 56 which face one another and which are integrally formed, i.e. in one piece or monolithically, on the inner face 34 of the cable deflection region 24. The bearing surfaces 54 and 56 are disposed substantially parallel in the XZ-plane and spaced apart from one another in the Y-direction.

The bearing surface 54 has two lateral reinforcing or holding ribs 58, which are spaced apart from one another in the X-direction and between which a transverse surface 60 is provided. The bearing surface 56 is configured as a counter rib which is disposed opposing one of the holding ribs 58. For example, in this case a second counter rib of the bearing surface 56, which is disposed opposing the other holding rib 58, is provided.

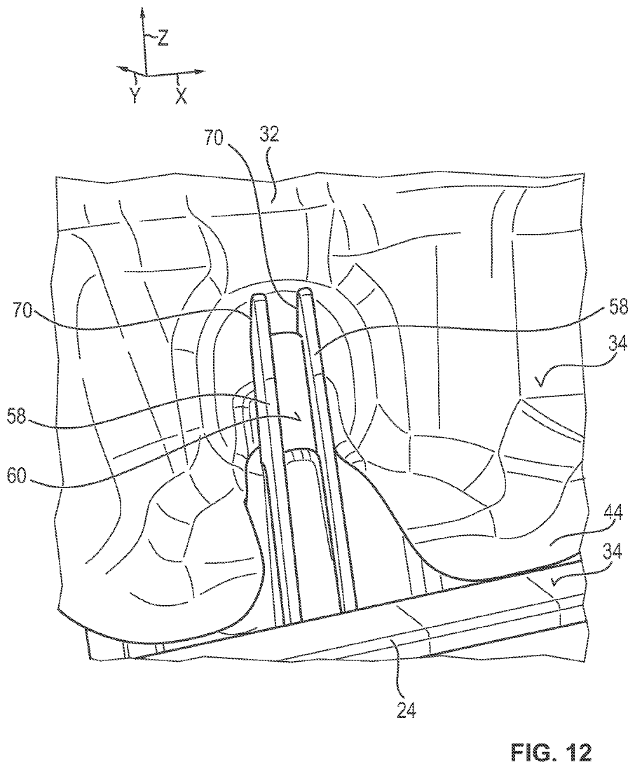

The receiving contour 42′ is shown in FIG. 11. The receiving contour 42′ is not closed over the periphery, in contrast to the receiving contour 42, but is configured to be open in the direction of the joining contour 46′ or in the direction of the carrier plate 28. The receiving contour 42′ in this case has a mating surface 62 which—as visible in FIG. 12—is form-lockingly gripped or grippable between the bearing surfaces 54 and 56 of the joining contour 46′.

The mating surface 62 has two surfaces 64, 66 which transition into one another through a stepped contour 68. The surfaces 64 and 66 are oriented substantially in the XZ-plane and thus parallel to the bearing surfaces 54, 56, whereby a stepped or shoulder-shaped surface offset is produced in the Y-direction by the stepped contour 68. The stepped contour 68 thus produces a tolerance compensation in the Y-direction during the mounting procedure.

In order to mount or join the door structure 32 to the cable deflection region 24, the receiving contour 42′ is inserted in the Z-direction into the receiver formed between the bearing surfaces 54, 56, so that the surfaces 64, 66 of the mating surface 62 are encompassed at least in some sections by the bearing surfaces 54, 56.

For a simplified insertion of the mating surface 62 between the bearing surfaces 54, 56, the free ends of the holding ribs 58, i.e. the regions of the holding ribs 58 protruding over the transverse surface 60 in the Z-direction, are provided with a lead-in portion or bevel 70 as a guide contour. The lead-in portion 70 in this case has a path tapering toward the tip. In other words, an inclined slope which acts as an insertion or positioning aid when joining the door structure 32 to the cable deflection region 24 is formed in the Z-direction.

Preferably, the holding ribs 58 of the joining contour 46′ are configured flexibly or resiliently, wherein in the mounted or joined state a spring force or restoring force which is oriented in the Y-direction is generated, the force producing a clamped force-locking of the mating surface 62 between the bearing surfaces 54, 56 as a mechanical pretensioning.

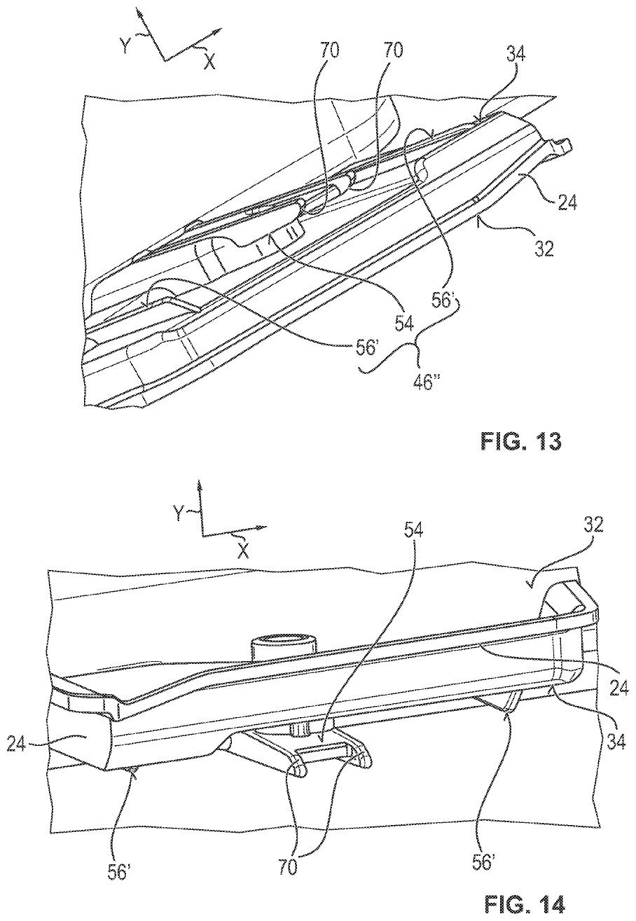

A third exemplary embodiment of the receiving contour 42″ and the joining contour 46″ is described in more detail hereinafter with reference to FIGS. 13 to 16.

In this embodiment, the joining contour 46″ shown in FIG. 13 and in FIG. 14 has two bearing surfaces 54′ and 56′ which face one another and which are integrally formed, i.e. in one piece or monolithically, on the inner face 34 of the cable deflection region 24. In this exemplary embodiment, the bearing surface 56′ is configured as two holding ribs which are disposed in the X-direction offset on both sides relative to the bearing surface 54.

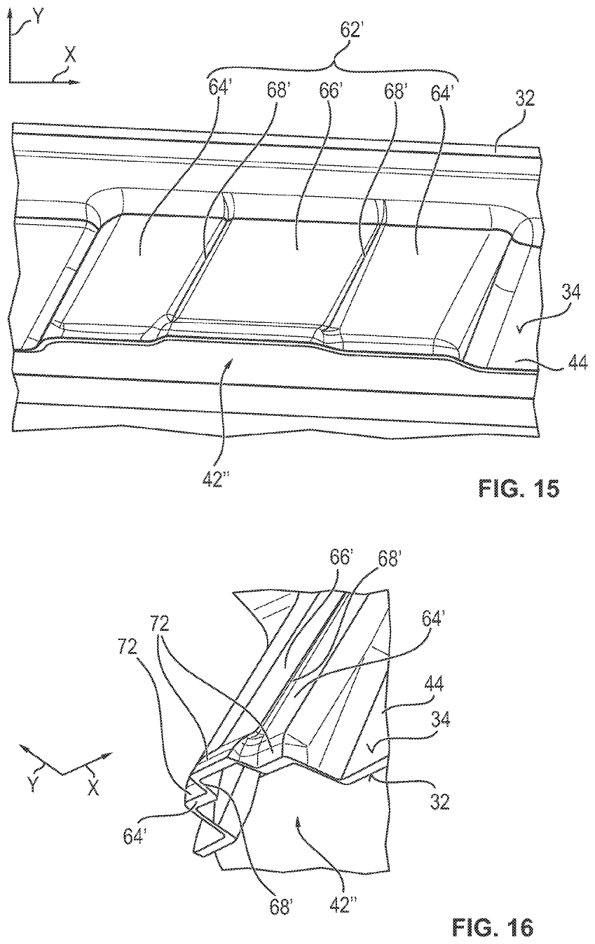

FIGS. 15 and 16 show the receiving contour 42″. The receiving contour 42″ in this case has a mating surface 62′. In this embodiment, the mating surface 62′ has two surfaces 64′ and one surface 66′ which are disposed alternating or alternately in the X-direction. In this case, the centrally disposed surface 66′ is disposed in each case through a stepped contour 68′ so as to be offset relative to the surfaces 64′. The surface 66′ protrudes over or above the surfaces 64′ thus at least in some sections in the Y-direction.

As is visible, in particular, in FIG. 16, the mating surface 62′ or the surfaces 64′, 66′ are provided with a lead-in portion or bevel 72 at the free end side.

The invention is not limited to the exemplary embodiments described above. Rather, other variants of the invention may be derived therefrom by the person skilled in the art without departing from the subject of the invention. In particular, all of the individual features described in connection with the exemplary embodiments may also be combined together in a different manner without departing from the subject of the invention.

In particular, other cross-sectional shapes of the joining contour 46, 46′, 46″ and/or the receiving contour 42, 42′, 42″ are also conceivable. The conjunction “and/or” is to be understood here and hereinafter in such a way that the features linked together by using this conjunction may be configured both together and as alternatives to one another.

It is also conceivable, for example, that the joining contour 46′, 46″ or the bearing surfaces 54, 54′, 56, 56′ are formed by using different components. It is also conceivable that the mating surface 62, 62′ is configured in multiple pieces, in particular it is possible that the surfaces 64, 64′, 66, 66′ are formed from two different components.

It is also conceivable, for example, that the joining contour 46′, 46′ is provided with a damping element.

The following is a summary list of reference numerals and the corresponding structure used in the above description of the invention.

### LIST OF REFERENCE NUMERALS

2 Window regulator
4 Windowpane
6 Actuating motor
8 Actuating mechanism
10 Guide rail
12 Rail sliding element/driver element
14 Cable pull
16 Worm drive, spur gear drive
18 Cable drum
20 Cable deflection pulley
22 Cable deflection pulley
24 Cable deflection region
26 Bearing point
28 Carrier plate
30 Door module
32 Door structure
34 Inner face
36 Outer face
38 Fastening opening
40 Edge
42, 42′, 42″ Receiving contour
42a Guide slot
42b Insertion region
44 Operating region
46, 46′, 46″ Joining contour
48 T-shaped limb
50 T-shaped limb
52 Reinforcing rib
54, 54′, 56, 56′ Bearing surface
58 Reinforcing rib/holding rib
60 Transverse surface
62, 62′ Mating surface
64, 64′, 66, 66′ Surface
68, 68′ Stepped contour
70, 72 Lead-in portion
S Closed position
O Open position
P Pane position
X Vehicle longitudinal direction
Y Vehicle transverse direction
Z Vehicle vertical direction
M Mounting direction

1. A door module of a vehicle door, the door module comprising:
a carrier plate including a cable window regulator having at least one guide rail, said carrier plate having an outer edge;
a door structure joined or to be joined to said carrier plate, said door structure having a receiving contour;
said guide rail having a cable deflection region extending beyond said outer edge of said carrier plate;
said cable deflection region having a joining contour form-lockingly inserted in said receiving contour in a joined state; and
said joining contour engaging behind said receiving contour and holding and stabilizing said cable deflection region in a direction perpendicular to said cable deflection region.

2. The door module according to claim 1, wherein said cable deflection region has a bearing point without screws or bolts, and a cable deflection roller is rotatably mounted on said bearing point.

3. The door module according to claim 2, wherein said joining contour is disposed on a side of said cable deflection region opposing said bearing point.

4. The door module according to claim 1, wherein said joining contour is inserted or insertable in said receiving contour in a rail longitudinal direction of said guide rail.

5. The door module according to claim 1, wherein at least said cable deflection region is an injection-molded part, and said joining contour is integrally formed on said cable deflection region.

6. The door module according to claim 5, wherein said joining contour is injection-molded without a slide.

7. The door module according to claim 1, wherein said joining contour has a T-shaped cross-sectional shape.

8. The door module according to claim 7, wherein said T-shaped cross-sectional shape of said joining contour includes:
a vertical T-shaped limb engaging form-lockingly in a guide slot of said receiving contour, and
a horizontal T-shaped limb engaging behind said receiving contour.

9. The door module according to claim 1, wherein said joining contour has two bearing surfaces facing one another for said door structure, and said receiving contour has a mating surface form-lockingly gripped between said bearing surfaces.

10. The door module according to claim 9, wherein said mating surface has a stepped contour encompassed by said bearing surfaces.

11. The door module according to claim 9, wherein at least one of said bearing surfaces has a free end side with a lead-in portion.

12. The door module according to claim 9, wherein said joining contour is at least partially resilient.

13. The door module according to claim 9, wherein said joining contour has a damping element.

14. The door module according to claim 1, wherein said joining contour has a reinforcing rib.

15. A door module of a vehicle door, the door module comprising:
a carrier plate including a cable window regulator having at least one guide rail, said carrier plate having an outer edge;
a door structure joined or to be joined to said carrier plate, said door structure having a one-piece or multipiece receiving contour;
said guide rail having a cable deflection region extending beyond said outer edge of said carrier plate;
said cable deflection region having a multipiece joining contour form-lockingly inserted in said receiving contour in a joined state; and
said joining contour engaging behind said receiving contour and holding and stabilizing said cable deflection region in a direction perpendicular to said cable deflection region.

16. The door module according to claim 15, wherein said cable deflection region has a bearing point without screws or bolts, and a cable deflection roller is rotatably mounted on said bearing point.

17. The door module according to claim 16, wherein said joining contour is disposed on a side of said cable deflection region opposing said bearing point.

18. The door module according to claim 15, wherein said joining contour is inserted or insertable in said receiving contour in a rail longitudinal direction of said guide rail.

19. The door module according to claim 15, wherein at least said cable deflection region is an injection-molded part, and said joining contour is integrally formed on said cable deflection region.

20. The door module according to claim 19, wherein said joining contour is injection-molded without a slide.

21. The door module according to claim 15, wherein said joining contour has a T-shaped cross-sectional shape.

22. The door module according to claim 21, wherein said T-shaped cross-sectional shape of said joining contour includes:
a vertical T-shaped limb engaging form-lockingly in a guide slot of said receiving contour, and
a horizontal T-shaped limb engaging behind said receiving contour.

23. The door module according to claim 15, wherein said joining contour has two bearing surfaces facing one another for said door structure, and said receiving contour has a mating surface form-lockingly gripped between said bearing surfaces.

24. The door module according to claim 23, wherein said mating surface has a stepped contour encompassed by said bearing surfaces.

25. The door module according to claim 23, wherein at least one of said bearing surfaces has a free end side with a lead-in portion.

26. The door module according to claim 23, wherein said joining contour is at least partially resilient.

27. The door module according to claim 23, wherein said joining contour has a damping element.

28. The door module according to claim 15, wherein said joining contour has a reinforcing rib.

29. A vehicle door, comprising a door module according to claim 1.

30. A vehicle door, comprising a door module according to claim 15.
